(19) United States
(12) Patent Application Publication
(10) Pub. No.: US 2021/0206685 A1
(43) Pub. Date: Jul. 8, 2021

(54) METHOD FOR GLASS SHEET SEPARATION

(71) Applicant: Corning Incorporated, Corning, NY (US)

(72) Inventors: James William Brown, Painted Post, NY (US); Tatyana Vyacheslavovna Brown, Elmira, NY (US); Zung-Sing Chang, Horseheads, NY (US); Marvin William Kemmerer, Odessa, NY (US); Xinghua Li, Horseheads, NY (US); Weiwei Luo, Painted Post, NY (US); Gaozhu Peng, Horseheads, NY (US); Wei Xu, Horseheads, NY (US)

(21) Appl. No.: 15/999,748

(22) PCT Filed: Feb. 13, 2017
(86) PCT No.: PCT/US2017/017592

§ 371 Date: Aug. 20, 2018

Related U.S. Application Data
(60) Provisional application No. 62/297,428, filed on Feb. 19, 2016.

(51) Int. Cl. C03B 33/02; C03B 33/09; C03B 33/033

(52) U.S. Cl. CPC C03B 33/0215; C03B 33/033; C03B 33/091

(57) ABSTRACT

A method for separating a glass sheet from a glass ribbon is provided in which the glass ribbon has a bead region and a quality region. The method includes scoring a score line across a surface of the quality region and applying an energy source, such as a burner or laser, to at least one surface of the bead region so as to generate a thermal gradient between the surface and the center of the bead region in the thickness direction.

This application claims the benefit of priority under 35 U.S.C. § 119 of U.S. Provisional Application Ser. No. 62/297,428, filed on Feb. 19, 2016, the content of which is relied upon and incorporated herein by reference in its entirety.

### BACKGROUND

### Field

The present invention relates generally to methods for glass sheet separation and more specifically to methods for separating a glass sheet from a glass ribbon.

### Technical Background

One of the processes of manufacturing high-quality flat glass involves flowing molten glass flow over the sides of a forming apparatus and fusing a ribbon at the root of the apparatus. To minimize ribbon width attenuation, the edges of the ribbon are typically pinched by edge rolls shortly below the root and then by sets of pulling rolls down the draw. The edge regions in contact with the rolls are usually significantly thicker than the region in between them, which includes the area from which glass sheets are produced, sometimes referred to as the “quality area.” Conversely, the relatively thicker edge regions are sometimes referred to as the “bead area” and typically have irregular thickness or knurl patterns due to edge roll grabbing.

Following contact with edge rolls, the ribbon travels downward through an annealing zone where it is cooled in a controlled manner to minimize thermal stress and ribbon warp. Following travel through this zone, the glass is eventually cooled to the point that the ribbon can be scored for eventual separation into sheets. A scoring operation may typically consist of scoring inside the bead region and through the width of the quality area. Following scoring, a glass sheet is separated from the glass ribbon by, for example, engaging the sheet and bending it about a nosing that is on the opposite side of the ribbon as the score line, such that separation between the ribbon and sheet occurs along the score line.

Due in large part to the relatively high thickness of the bead regions, significant energy is typically required to bend and separate the sheet from the ribbon. Such excess energy can result in significant vibration of the upstream ribbon and thereby negatively impact forming process. In addition, in the case of thinner or wider ribbons, crack propagation over the beaded areas may not follow the same linear path as the score line. Moreover, higher amounts of energy needed to bend and separate the sheet from the ribbon correlate to higher amount of undesirable particle generation, which particles often end up attached to the glass surface, negatively affecting surface quality, and often requiring intensive downstream processing steps to clean and remove them.

Prior attempts to reduce the amount of energy required to separate glass sheets from a ribbon have included attempts to mechanically cut or score an area along the bead regions. However, these have proven to be inadequate due to the fact that the knurl area has irregular thickness (i.e., peaks and valleys) and the valleys were deep enough not to be touched by the scoring mechanism. Other alternatives, such as grinding the bead regions to a reduced thickness, involve prohibitive complexity.

### SUMMARY

A method for separating a glass sheet from a glass ribbon is disclosed. The glass ribbon includes a bead region, a transition region adjacent to the bead region in the widthwise direction, and a quality region adjacent to the transition region in the widthwise direction. The method includes scoring a score line across a first surface of the quality region of the glass ribbon in the widthwise direction. The method also includes applying an energy source to at least one surface of the bead region next to the score line, thereby generating a thermal gradient between the at least one surface and the center of the bead region in the thickness direction, wherein the at least one surface has a temperature that is higher than the center of the bead region. In addition, the method includes separating the glass sheet from the glass ribbon along the score line.

Additional features and advantages of the embodiments disclosed herein will be set forth in the detailed description which follows, and in part will be readily apparent to those skilled in the art from that description or recognized by practicing the embodiments as described herein, including the detailed description which follows, the claims, as well as the appended drawings.

It is to be understood that both the foregoing general description and the following detailed description present embodiments intended to provide an overview or framework for understanding the nature and character of the claims. The accompanying drawings are included to provide further understanding, and are incorporated into and constitute a part of this specification. The drawings illustrate various embodiments of the disclosure, and together with the description serve to explain the principles and operations thereof.

### BRIEF DESCRIPTION OF THE DRAWINGS

FIG. 1 is a schematic view of an example fusion down draw glass making process;

FIG. 2 is a top cutaway view of a scoring process using a score wheel;

FIG. 3 is a an expanded view of the scoring process shown in FIG. 2 relative to one end of a glass ribbon, showing a bead region, a transition region, and a quality region;

FIG. 4 is an expanded view of a scoring and separation process relative to one end of a glass ribbon according to embodiments herein, wherein an energy source comprising an open flame is applied to one surface of a bead region;

FIG. 5 is a schematic end view of the scoring and separation process of FIG. 4, wherein an angle between an incidence direction of the energy source and a plane perpendicular to the lengthwise direction of the ribbon is allowed to vary;

FIG. 6 is an expanded view of a scoring and separation process relative to one end of a glass ribbon according to embodiments herein, wherein an energy source comprising a laser is applied to one surface of a bead region;

FIG. 7 is a schematic end view of the scoring and separation process of FIG. 6, wherein an angle between an incidence direction of the energy source and a plane perpendicular to the lengthwise direction of the ribbon is allowed to vary;

FIGS. 8A and B are schematic end views showing separation of a glass sheet from the glass ribbon;

FIG. 9 is a graph showing the energy for separating a glass sheet from a glass ribbon as well as bead surface temperatures under various conditions;

FIG. 10 is a graph showing the temperature distribution of a portion of a hot glass sheet wherein laser energy has been applied to one side of the sheet; and

FIG. 11 is a graph showing the stress distribution of a portion of a glass sheet wherein laser energy has been applied to one side of the sheet.

### DETAILED DESCRIPTION

Reference will now be made in detail to the present preferred embodiments of the present disclosure, examples of which are illustrated in the accompanying drawings. Whenever possible, the same reference numerals will be used throughout the drawings to refer to the same or like parts. However, this disclosure may be embodied in many different forms and should not be construed as limited to the embodiments set forth herein.

Ranges can be expressed herein as from “about” one particular value, and/or to “about” another particular value. When such a range is expressed, another embodiment includes from the one particular value and/or to the other particular value. Similarly, when values are expressed as approximations, for example by use of the antecedent “about,” it will be understood that the particular value forms another embodiment. It will be further understood that the endpoints of each of the ranges are significant both in relation to the other endpoint, and independently of the other endpoint.

Directional terms as used herein—for example up, down, right, left, front, back, top, bottom—are made only with reference to the figures as drawn and are not intended to imply absolute orientation.

Unless otherwise expressly stated, it is in no way intended that any method set forth herein be construed as requiring that its steps be performed in a specific order, nor that with any apparatus specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred, in any respect. This holds for any possible non-express basis for interpretation, including: matters of logic with respect to arrangement of steps, operational flow, order of components, or orientation of components; plain meaning derived from grammatical organization or punctuation, and; the number or type of embodiments described in the specification.

As used herein, the singular forms “a,” “an” and “the” include plural referents unless the context clearly dictates otherwise. Thus, for example, reference to “a” component includes aspects having two or more such components, unless the context clearly indicates otherwise.

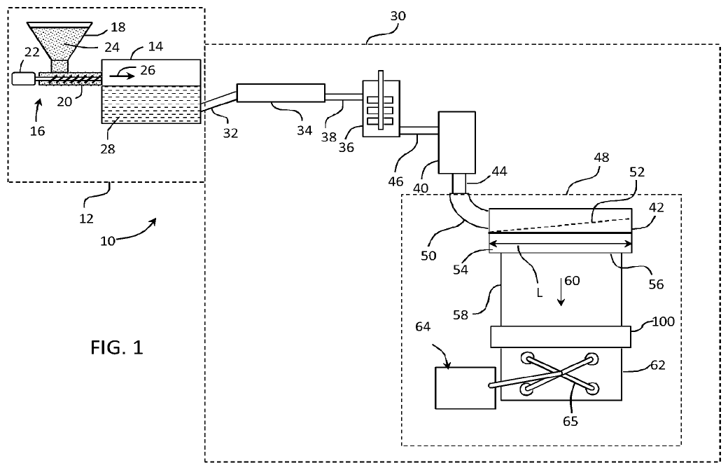

Shown in FIG. 1 is an exemplary glass manufacturing apparatus 10. In some examples, the glass manufacturing apparatus 10 can comprise a glass melting furnace 12 that can include a melting vessel 14. In addition to melting vessel 14, glass melting furnace 12 can optionally include one or more additional components such as heating elements (e.g., combustion burners or electrodes) that heat raw materials and convert the raw materials into molten glass. In further examples, glass melting furnace 12 may include thermal management devices (e.g., insulation components) that reduce heat lost from a vicinity of the melting vessel. In still further examples, glass melting furnace 12 may include electronic devices and/or electromechanical devices that facilitate melting of the raw materials into a glass melt. Still further, glass melting furnace 12 may include support structures (e.g., support chassis, support member, etc.) or other components.

Glass melting vessel 14 is typically comprised of refractory material, such as a refractory ceramic material, for example a refractory ceramic material comprising alumina or zirconia. In some examples glass melting vessel 14 may be constructed from refractory ceramic bricks.

In some examples, the glass melting furnace may be incorporated as a component of a glass manufacturing apparatus to fabricate a glass substrate, for example a glass ribbon of a continuous length. In some examples, the glass melting furnace of the disclosure may be incorporated as a component of a glass manufacturing apparatus comprising a slot draw apparatus, a float bath apparatus, a down-draw apparatus such as a fusion process, an up-draw apparatus, a press-rolling apparatus, a tube drawing apparatus or any other glass manufacturing apparatus that would benefit from the aspects disclosed herein. By way of example, FIG. 1 schematically illustrates glass melting furnace 12 as a component of a fusion down-draw glass manufacturing apparatus 10 for fusion drawing a glass ribbon for subsequent processing into individual glass sheets.

The glass manufacturing apparatus 10 (e.g., fusion down-draw apparatus 10) can optionally include an upstream glass manufacturing apparatus 16 that is positioned upstream relative to glass melting vessel 14. In some examples, a portion of, or the entire upstream glass manufacturing apparatus 16, may be incorporated as part of the glass melting furnace 12.

As shown in the illustrated example, the upstream glass manufacturing apparatus 16 can include a storage bin 18, a raw material delivery device 20 and a motor 22 connected to the raw material delivery device. Storage bin 18 may be configured to store a quantity of raw materials 24 that can be fed into melting vessel 14 of glass melting furnace 12, as indicated by arrow 26. Raw materials 24 typically comprise one or more glass forming metal oxides and one or more modifying agents. In some examples, raw material delivery device 20 can be powered by motor 22 such that raw material delivery device 20 delivers a predetermined amount of raw materials 24 from the storage bin 18 to melting vessel 14. In further examples, motor 22 can power raw material delivery device 20 to introduce raw materials 24 at a controlled rate based on a level of molten glass sensed downstream from melting vessel 14. Raw materials 24 within melting vessel 14 can thereafter be heated to form molten glass 28.

Glass manufacturing apparatus 10 can also optionally include a downstream glass manufacturing apparatus 30 positioned downstream relative to glass melting furnace 12. In some examples, a portion of downstream glass manufacturing apparatus 30 may be incorporated as part of glass melting furnace 12. In some instances, first connecting conduit 32 discussed below, or other portions of the downstream glass manufacturing apparatus 30, may be incorporated as part of glass melting furnace 12. Elements of the downstream glass manufacturing apparatus, including first connecting conduit 32, may be formed from a precious metal. Suitable precious metals include platinum group metals selected from the group of metals consisting of platinum, iridium, rhodium, osmium, ruthenium and palladium, or alloys thereof. For example, downstream components of the glass manufacturing apparatus may be formed from a platinum-rhodium alloy including from about 70 to about 90% by weight platinum and about 10% to about 30% by weight rhodium. However, other suitable metals can include molybdenum, palladium, rhenium, tantalum, titanium, tungsten and alloys thereof.

Downstream glass manufacturing apparatus 30 can include a first conditioning (i.e., processing) vessel, such as fining vessel 34, located downstream from melting vessel 14 and coupled to melting vessel 14 by way of the above-referenced first connecting conduit 32. In some examples, molten glass 28 may be gravity fed from melting vessel 14 to fining vessel 34 by way of first connecting conduit 32. For instance, gravity may cause molten glass 28 to pass through an interior pathway of first connecting conduit 32 from melting vessel 14 to fining vessel 34. It should be understood, however, that other conditioning vessels may be positioned downstream of melting vessel 14, for example between melting vessel 14 and fining vessel 34. In some embodiments, a conditioning vessel may be employed between the melting vessel and the fining vessel wherein molten glass from a primary melting vessel is further heated to continue the melting process, or cooled to a temperature lower than the temperature of the molten glass in the melting vessel before entering the fining vessel.

Bubbles may be removed from molten glass 28 within fining vessel 34 by various techniques. For example, raw materials 24 may include multivalent compounds (i.e. fining agents) such as tin oxide that, when heated, undergo a chemical reduction reaction and release oxygen. Other suitable fining agents include without limitation arsenic, antimony, iron and cerium. Fining vessel 34 is heated to a temperature greater than the melting vessel temperature, thereby heating the molten glass and the fining agent. Oxygen bubbles produced by the temperature-induced chemical reduction of the fining agent(s) rise through the molten glass within the fining vessel, wherein gases in the molten glass produced in the melting furnace can diffuse or coalesce into the oxygen bubbles produced by the fining agent. The enlarged gas bubbles can then rise to a free surface of the molten glass in the fining vessel and thereafter be vented out of the fining vessel. The oxygen bubbles can further induce mechanical mixing of the molten glass in the fining vessel.

Downstream glass manufacturing apparatus 30 can further include another conditioning vessel such as a mixing vessel 36 for mixing the molten glass. Mixing vessel 36 may be located downstream from the fining vessel 34. Mixing vessel 36 can be used to provide a homogenous glass melt composition, thereby reducing cords of chemical or thermal inhomogeneity that may otherwise exist within the fined molten glass exiting the fining vessel. As shown, fining vessel 34 may be coupled to mixing vessel 36 by way of a second connecting conduit 38. In some examples, molten glass 28 may be gravity fed from the fining vessel 34 to mixing vessel 36 by way of second connecting conduit 38. For instance, gravity may cause molten glass 28 to pass through an interior pathway of second connecting conduit 38 from fining vessel 34 to mixing vessel 36. It should be noted that while mixing vessel 36 is shown downstream of fining vessel 34, mixing vessel 36 may be positioned upstream from fining vessel 34. In some embodiments, downstream glass manufacturing apparatus 30 may include multiple mixing vessels, for example a mixing vessel upstream from fining vessel 34 and a mixing vessel downstream from fining vessel 34. These multiple mixing vessels may be of the same design, or they may be of different designs.

Downstream glass manufacturing apparatus 30 can further include another conditioning vessel such as delivery vessel 40 that may be located downstream from mixing vessel 36. Delivery vessel 40 may condition molten glass 28 to be fed into a downstream forming device. For instance, delivery vessel 40 can act as an accumulator and/or flow controller to adjust and/or provide a consistent flow of molten glass 28 to forming body 42 by way of exit conduit 44. As shown, mixing vessel 36 may be coupled to delivery vessel 40 by way of third connecting conduit 46. In some examples, molten glass 28 may be gravity fed from mixing vessel 36 to delivery vessel 40 by way of third connecting conduit 46. For instance, gravity may drive molten glass 28 through an interior pathway of third connecting conduit 46 from mixing vessel 36 to delivery vessel 40.

Downstream glass manufacturing apparatus 30 can further include forming apparatus 48 comprising the above-referenced forming body 42 and inlet conduit 50. Exit conduit 44 can be positioned to deliver molten glass 28 from delivery vessel 40 to inlet conduit 50 of forming apparatus 48. For example in examples, exit conduit 44 may be nested within and spaced apart from an inner surface of inlet conduit 50, thereby providing a free surface of molten glass positioned between the outer surface of exit conduit 44 and the inner surface of inlet conduit 50. Forming body 42 in a fusion down draw glass making apparatus can comprise a trough 52 positioned in an upper surface of the forming body and converging forming surfaces 54 that converge in a draw direction along a bottom edge 56 of the forming body. Molten glass delivered to the forming body trough via delivery vessel 40, exit conduit 44 and inlet conduit 50 overflows side walls of the trough and descends along the converging forming surfaces 54 as separate flows of molten glass. The separate flows of molten glass join below and along bottom edge 56 to produce a single ribbon of glass 58 that is drawn in a draw direction 60 from bottom edge 56 by applying tension to the glass ribbon, such as by gravity, edge rolls and pulling rolls (not shown), to control the dimensions of the glass ribbon as the glass cools and a viscosity of the glass increases. Accordingly, glass ribbon 58 goes through a visco-elastic transition and acquires mechanical properties that give the glass ribbon 58 stable dimensional characteristics. Glass ribbon 58 may in some embodiments be separated into individual glass sheets 62 by a glass separation apparatus 100 in an elastic region of the glass ribbon. A robot 64 may then transfer the individual glass sheets 62 to a conveyor system using gripping tool 65, whereupon the individual glass sheets may be further processed.

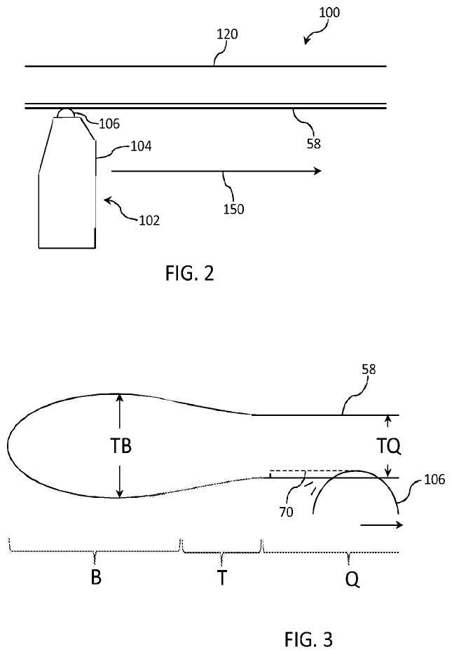

As shown in FIG. 2, glass separation apparatus 100 includes scoring apparatus 102, which includes scoring element housing 104, and scoring element (score wheel) 106. Glass separation apparatus 100 also includes nosing bar 120. In operation, scoring apparatus 102 moves in the direction shown by arrow 150 in scoring a score line across a first surface of the glass ribbon 58 while nosing bar 120 is applied against a second surface of the glass ribbon 58. Following scoring, individual glass sheets 62 may be separated from glass ribbon 58 along the score line by, for example, bending the glass ribbon 58 against the nosing bar 120.

FIG. 3 illustrates an expanded view of the scoring process shown in FIG. 2 relative to one end of glass ribbon 58. Specifically, FIG. 3 shows bead region (B), transition region (T) adjacent to the bead region in the widthwise direction, and quality region (Q) adjacent to the transition region in the widthwise direction. As can be seen from FIG. 3, the maximum thickness (TB) of the bead region is substantially greater than the maximum thickness (TQ) of the quality region and can, for example, be at least twice the thickness of the quality region, including at least three times the thickness of the quality region, and further including at least four times the thickness of the quality region. As can also be seen in FIG. 3, score line 70 only extends along the quality region. In other words, score line 70 does not extend along any portion of the bead region or the transition region in the widthwise direction. In other exemplary embodiments (not shown), score line may extend along at least a portion of the transition region in the widthwise direction but does not extend along any portion of the bead region.

In embodiments disclosed herein, score line 70 may extend a predetermined distance within the thickness of the glass ribbon 58 such as at least 1%, including at least 5%, and further including at least 10%, and still yet further at least 20% of the thickness of the glass ribbon, such as from 1% to 25% of the thickness of the glass ribbon, including from 5% to 15%, including about 10% of the thickness of glass ribbon 58.

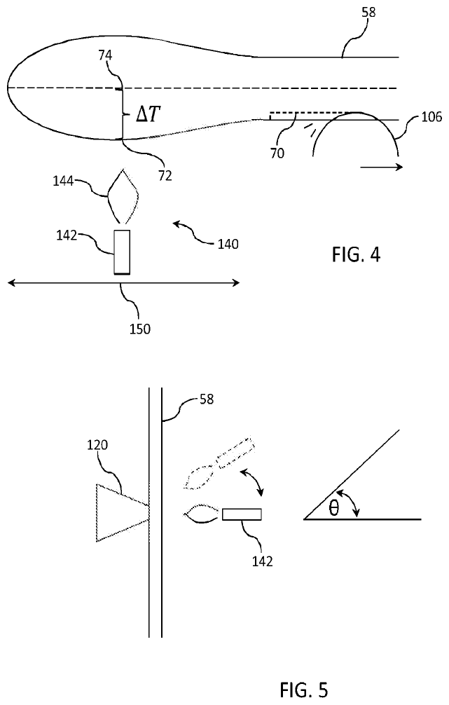

FIG. 4 shows an expanded view of a scoring and separation process relative to one end of a glass ribbon according to embodiments herein. In the embodiment of FIG. 4, an energy source 140 is applied to one surface of a bead region, wherein energy source 140 includes a burner 142 that applies an open flame 144 to a surface of the bead region. Open flame 144 may result from the combustion of any combustible fuel within burner 142. Combustible fuel may, for example, comprise at least one component selected from the group consisting of hydrocarbons and hydrogen.

In certain exemplary embodiments, open flame 144 is generated by hydrogen combustion. For example, a pin point hydrogen burner may be used to generate open flame 144, such as an H₂O welder available from SRA Soldering Products. Such hydrogen may, for example, be generated by dissociating distilled water with low voltage electricity.

As shown by arrow 150 in FIG. 4, burner 142 may scan back and forth in the widthwise. For example, burner 142 may make at least 1, such as at least 2, and further such as at least 5, and yet further such as at least 10, and still yet further such as at least 20, including from 1 to 100, such as from 2 to 50, and further such as from 5 to 20 back and forth scans in the widthwise direction at, for example, a scanning speed of at least about 1 millimeter per second, such as at least about 2 millimeters per second, and further such as at least about 5 millimeters per second, and yet further such as at least about 10 millimeters per second, including from about 1 to about 100 millimeters per second, such as from about 2 to about 50 millimeters per second, and further such as from about 5 to about 20 millimeters per second. When scanning back and forth in the widthwise direction, the scan speed of burner 142 may be approximately constant or it may vary. For example, the scan speed of the burner may be relatively faster or relatively slower depending on the expected bead thickness, such as relatively slower where the bead thickness is expected to be relatively thicker so as to apply a greater amount of energy to the relatively thicker area. Burner 142 may also remain stationary.

Scan width of burner 142 in the widthwise direction will generally correlate to the width of the bead region and, while not limited, may, for example range from about 5 to about 100 millimeters, such as from about 10 to about 50 millimeters, and further such as from about 15 to about 30 millimeters. In certain exemplary embodiments, scan width of burner may extend into transition region but not overlap with score line 70 and, along those lines, embodiments herein include those in which a widthwise gap exists between the closest point on the score line 70 to the closest widthwise movement of the burner 142 toward the score line 70, such as a gap of at least about 1 millimeter, including at least about 5 millimeters, and further including at least about 10 millimeters, such as from about 1 to about 40 millimeters, and further such as from about 5 to about 20 millimeters.

The distance between a tip of burner 142 and a closest surface 72 of bead region of glass ribbon 58 should be in a range to allow for a thermal gradient (ΔT) to develop between surface 72 and center 74 of the bead region in the thickness direction without overly heating surface 72. For example, the distance between a tip of burner 142 and surface 72 can range from about 5 to about 100 millimeters, such as from about 10 to about 50 millimeters, and further such as from about 15 to about 25 millimeters.

The temperature of open flame 144 can, for example, be adjusted by varying the size of the tips used on the burner. In that regard, tips with larger diameters can be expected to result in higher open flame temperatures. Exemplary embodiments herein can include those in which the temperature of the open flame is at least about 1000° C., such as at least about 1200° C., and further such as at least about 1500° C., and yet further such as at least about 2000° C., including from about 1000° C. to about 3000° C., such as from about 1500° C. to about 2500° C., which can be achieved using tips having interior diameters ranging from about 0.01 to about 0.05 inches.

While FIG. 4 illustrates an embodiment in which energy source 140 comprising burner 142 applies open flame 144 to the same side of glass ribbon 58 as score line 70, it is to be understood that embodiments disclosed herein also include those in which a second energy source may apply energy, such as an open flame or laser, to the opposite side of glass ribbon 58 as score line 70. For example, embodiments herein include those in which energy source 140 comprising burner 142 applies open flame 144 to the score line side of glass ribbon 58, the side of glass ribbon opposite the score line, or both sides. In addition, embodiments herein include those in which the glass ribbon comprises a bead region on both sides of the ribbon in the widthwise direction and an energy source comprising burner 142 is applied to at least one, if not both, sides of each bead region.

FIG. 5 illustrates a schematic end view of the scoring and separation process of FIG. 4. In the embodiment shown in FIG. 5, an angle (θ) between an incidence direction of the energy source (e.g., burner 142) and a plane perpendicular to the lengthwise direction of the glass ribbon 58 is allowed to vary. In certain exemplary embodiments, angle (θ) may range from about 0 to about 60 degrees, such as from about 15 to about 45 degrees. By allowing angle (θ) to vary, energy source (e.g., burner 142) may be positioned such that it does not interfere with scoring apparatus 102.

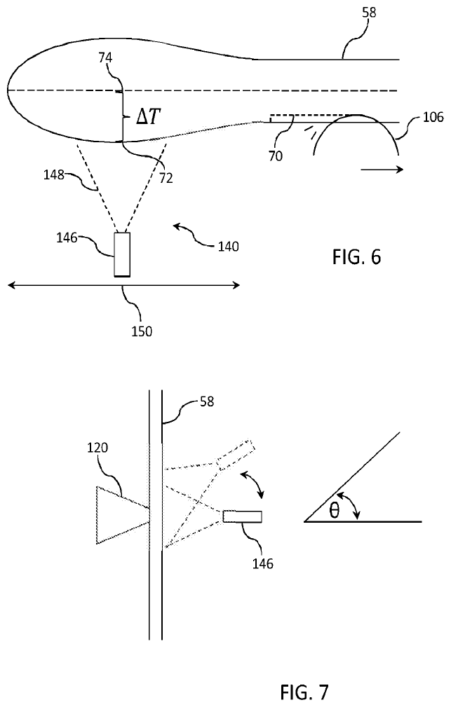

FIG. 6 shows an expanded view of a scoring and separation process relative to one end of a glass ribbon according to embodiments herein. In the embodiment of FIG. 4, an energy source 140 is applied to one surface of a bead region, wherein energy source 140 includes a laser 146 that applies a laser beam 148 to a surface of the bead region.

Exemplary lasers include CO and CO₂ lasers, such as the E-400 CO₂ laser available from Coherent, Inc. In certain exemplary embodiments, the laser may be operated with a variable laser beam focusing system in order to tune or vary the laser beam diameter on the glass, such as an XY galvonometer available from ScanLab. Using such, a line shaped laser beam of a defined length can be generated by rapidly rastering the laser beam. The length of the laser beam (i.e., the dimension of the laser beam that corresponds to the widthwise direction of the glass sheet) can, for example, be varied from about 10 to about 1,000 millimeters, such as from about 50 to about 500 millimeters, at scanning speeds ranging from, from example, about 1000 to about 20,000 millimeters per second. In this manner, the intensity distribution along the length of the beam can be controlled to be approximately constant whereas the intensity distribution along the width of the beam is approximately Gaussian.

In certain exemplary embodiments, the width of the laser beam can range from about 1 to about 20 millimeters, such as from about 2 to about 10 millimeters and the length of the laser beam can range from about 10 to about 100 millimeters, such as from about 30 to about 50 millimeters.

In certain exemplary embodiments, the power of the laser beam can range from about 20 watts to about 1000 watts, such as from about 30 watts to about 600 watts, and further such as from about 50 watts to about 300 watts, and still yet further such as from about 80 watts to about 150 watts, including about 100 watts. The laser may, for example, be operated at a repetition rate of from 10 kHz to 100 kHz, such as from 20 kHz to 60 kHz, including about 40 kHz.

As shown in FIG. 6, laser 146 may scan back and forth in the widthwise direction as shown by arrow 150. For example, laser 146 may make at least 1, such as at least 2, and further such as at least 5, and yet further such as at least 10, and still yet further such as at least 20, including from 1 to 100, such as from 2 to 50, and further such as from 5 to 20 back and forth scans in the widthwise direction at, for example, a scanning speed of at least about 1 millimeter per second, such as at least about 2 millimeters per second, and further such as at least about 5 millimeters per second, and yet further such as at least about 10 millimeters per second, including from about 1 to about 100 millimeters per second, such as from about 2 to about 50 millimeters per second, and further such as from about 5 to about 20 millimeters per second. When scanning back and forth in the widthwise direction, the scan speed of laser 146 may be approximately constant or it may vary. For example, the scan speed of the laser may be relatively faster or slower relative to the expected bead thickness, such as relatively slower where the bead thickness is expected to be relatively thicker so as to apply a greater amount of energy to the relatively thicker area. Laser 146 may also remain stationary.

When scanning back and forth in the widthwise direction, the power of laser 146 may be approximately constant or it may vary. For example, the power of the laser may be relatively greater or relatively less depending on the expected bead thickness, such as relatively greater where the bead thickness is expected to be relatively thicker so as to apply a greater amount of energy to the relatively thicker area.

When scanning back and forth in the widthwise direction, the pattern of laser 146 may be approximately constant or it may vary. For example, in certain exemplary embodiments laser may be moved not only in the widthwise direction but also in the lengthwise direction of the glass ribbon. For example, the lengthwise movement of the laser may be relatively greater or less relative to the expected bead thickness, such as relatively less where the bead thickness is expected to be relatively thicker so as to apply a greater amount of energy to the relatively thicker area.

Scan width of laser 146 in the widthwise direction will generally correlate to the width of the bead region and, while not limited, may, for example range from about 5 to about 100 millimeters, such as from about 10 to about 50 millimeters, and further such as from about 15 to about 30 millimeters. In certain exemplary embodiments, scan width of laser may extend into transition region but not overlap with score line 70 and, along those lines, embodiments herein include those in which a widthwise gap exists between the closest point on the score line 70 to the closest widthwise movement of the laser 146 toward the score line 70, such as a gap of at least about 1 millimeter, including at least about 5 millimeters, and further including at least about 10 millimeters, such as from about 1 to about 40 millimeters, and further such as from about 5 to about 20 millimeters.

In other exemplary embodiments, scan width of laser may overlap with score line and, along those lines, embodiments herein include those in which scan width of laser overlaps with score line for a length of at least about 1 millimeter, including at least about 5 millimeters, and further including at least about 10 millimeters, such as from about 1 to about 20 millimeters, and further such as from about 5 to about 15 millimeters.

While FIG. 6 illustrates an embodiment in which energy source 140 comprising laser 146 applies laser beam 148 to the same side of glass ribbon 58 as score line 70, it is to be understood that embodiments disclosed herein also include those in which a second energy source may apply energy, such as an open flame or laser, to the opposite side of glass ribbon 58 as score line 70. For example, embodiments herein include those in which energy source 140 comprising laser 146 applies laser beam 148 to the score line side of glass ribbon 58, the side of glass ribbon opposite the score line, or both sides. In addition, embodiments herein include those in which the glass ribbon comprises a bead region on both sides of the ribbon in the widthwise direction and an energy source comprising laser 146 is applied to at least one, if not both, sides of each bead region.

FIG. 7 illustrates a schematic end view of the scoring and separation process of FIG. 4. In the embodiment shown in FIG. 5, an angle (θ) between an incidence direction of the energy source (e.g., laser 146) and a plane perpendicular to the lengthwise direction of the glass ribbon 58 is allowed to vary. In certain exemplary embodiments, angle (θ) may range from about 0 to about 60 degrees, such as from about 15 to about 45 degrees. By allowing angle (θ) to vary, energy source (e.g., laser 146) may be positioned such that it does not interfere with scoring apparatus 102.

Application of energy source 140 as described herein, and shown, for example, in FIGS. 4-7, facilitates separation of glass sheets 62 from ribbon 58. Specifically, as shown, for example, in FIGS. 4 and 6, a score line 70 is scored across a first surface of the quality region of the glass ribbon 58 in the widthwise direction, by for example, applying a mechanical scoring apparatus comprising score wheel 106 to the first surface. During, before, and/or after creation of the score line 70, an energy source 140 is applied to at least one surface of the bead region next to the score line, thereby generating a thermal gradient between the at least one surface and the center of the bead region in the thickness direction, wherein the at least one surface has a temperature that is higher than the center of the bead region. In the embodiment shown in FIG. 4, during, before, and/or after creation of score line 70, energy source 140 comprising burner 142 applies an open flame 144 to the first surface 72 of the bead region, thereby generating a thermal gradient (ΔT) between the first surface and the center 74 of the bead region in the thickness direction. In the embodiment shown in FIG. 6, during, before, and/or after creation of score line 70, energy source 140 comprising laser 146 applies a laser beam 148 to the first surface 72 of the bead region, thereby generating a thermal gradient (ΔT) between the first surface and the center 74 of the bead region in the thickness direction. The glass sheet 62 is then separated from the glass ribbon 58 along the score line 70.

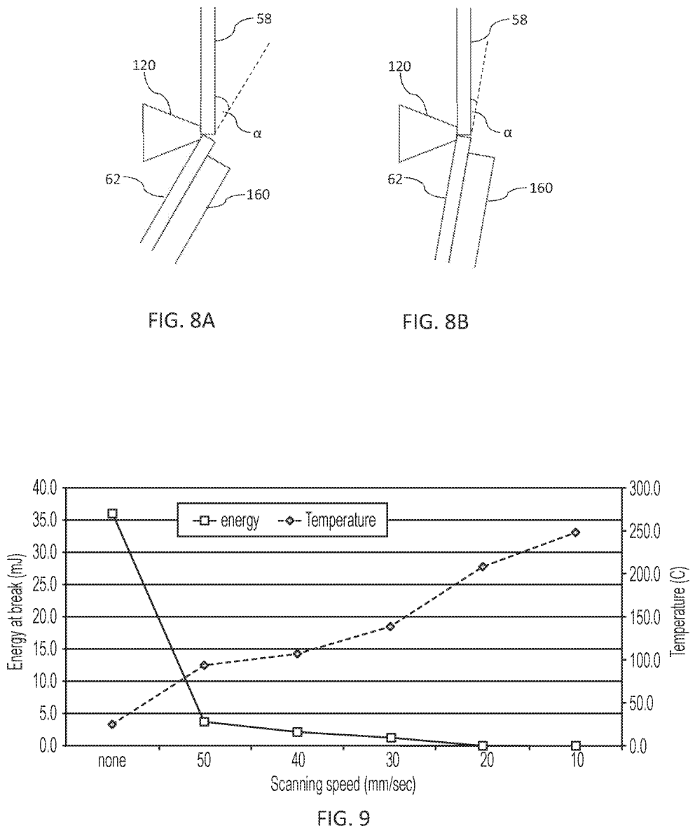

FIGS. 8A and B illustrate schematic end views showing separation of a glass sheet 62 from a glass ribbon 58 wherein the step of separating the glass sheet from the glass ribbon along the score line comprises using bending mechanism 160 to bend the glass sheet against nosing 120 that is applied widthwise along a second surface of the quality region opposite of the score line. Specifically, FIG. 8A illustrates separation of a glass sheet 62 from a glass ribbon 58 wherein an energy source is not applied to at least one surface of a bead region according to embodiments herein. In contrast, FIG. 8B illustrates separation of a glass sheet from a glass ribbon wherein an energy source is applied to at least one surface of a bead region according to embodiments herein.

As can be seen by comparing the two figures, the bend angle (a) in separating the glass sheet 62 from the glass ribbon 58 is much larger in FIG. 8A than it is in FIG. 8B. A larger bend angle generally correlates to more energy for separating the glass sheet 62 from the glass ribbon 58, which, in turn, correlates to greater vibration of the upstream ribbon as well as greater amounts of particle generation upon separation of the glass sheet 62 from the glass ribbon 58.

FIG. 9 is a graph showing the energy (in mJ) for separating an Eagle XG® glass sheet having a thickness of about 0.7 millimeters from a glass panel as well as the surface temperature (in ° C.) of the bead regions of the glass panel at the time of separation under different conditions with respect to application of an energy source, specifically a pin-point hydrogen burner to the bead regions on a score line side of the panel. In this case, the hydrogen burner was an H₂O welder available from SRA Soldering Products having a tip size with an interior diameter of at least about 0.01 inches wherein the distance between the tip and the glass surface was at least about 10 millimeters. The graph of FIG. 9 shows a condition in which the pin-point hydrogen burner was not applied to the bead regions as well as other conditions in which the hydrogen burner passed over the bead regions at least two times at scanning speeds ranging from 10 to 50 millimeters per second. As can be seen from FIG. 9, application of the hydrogen burner to the bead regions, even at the relatively faster scanning speed of 50 millimeters per second, resulted in a significant reduction in the amount of energy for separating the glass sheet from the glass panel. Reducing the speed of the burner resulted in an even greater reduction of the amount of energy for separating the glass sheet from the glass panel.

As illustrated by FIG. 9, embodiments herein can enable a significant reduction in the amount of energy for separating a glass sheet from a glass ribbon, such as at least about a 20% reduction, and further such as at least about a 30% reduction, and yet further such as at least about a 40% reduction, and still yet further such as at least about a 50% reduction, and even still yet further such as at least about a 60% reduction, including at least about a 70% reduction, and further including at least about an 80% reduction of the amount of energy for separating a glass sheet from a glass ribbon as compared to a condition wherein an energy source is not applied to the surface of a bead region according to embodiments herein. For example, embodiments herein can enable about a 20% to about a 90% reduction, such as about a 30% to about a 80% reduction, and further such as about a 40% to about a 70% reduction of the amount of energy for separating a glass sheet from a glass ribbon as compared to a condition wherein an energy source is not applied to the surface of a bead region according to embodiments herein.

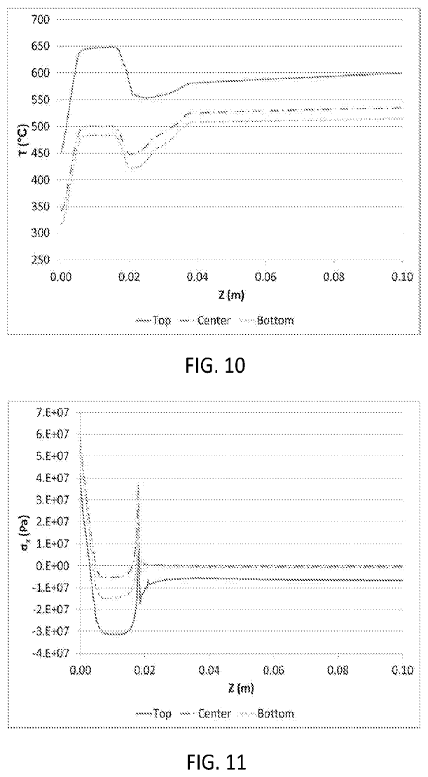

FIG. 10 is a graph showing the temperature distribution of a portion of a hot glass sheet wherein laser energy was applied to one side of the sheet. Specifically, two D-mode laser beams were applied to one side of a sheet of Eagle XG® glass available from Corning Incorporated having a thickness of about 0.5 millimeters and a width of about 1840 millimeters. The nominal size of each of the laser beams was about 2000 millimeters by 3 millimeters, the distance between the two beam centers was about 1000 millimeters, the power of each beam was about 1000 watts, with an application time of about 1 second. As can be seen from FIG. 10, application of the laser beams to one side of the glass sheet generates a thermal gradient between the side of the glass sheet to which the laser was applied (indicated in FIG. 10 as “top”) and the center of the sheet in the thickness direction (indicated in FIG. 10 as “center”), wherein the side of the glass sheet to which the laser was applied has a higher temperature than the center. A thermal gradient also exists between the center of the sheet and the side of the glass sheet opposite of the side to which the laser was applied (indicated in FIG. 10 as “bottom”), wherein the center of the glass sheet has a higher temperature than the opposite side of the glass sheet to which the laser was applied.

FIG. 11 is a graph showing the stress distribution of a portion of a glass sheet wherein laser energy was applied to one side of the sheet wherein the glass sheet and laser application conditions were the same as those described for FIG. 10. Specifically, FIG. 11 shows distribution of the stress component along the widthwise direction (shown as Z in FIG. 11) for a crack at about Z=18.5 millimeters, which is in the bead region, wherein compressive stresses are indicated as being negative and tensile stresses are indicated as being positive. As can be seen from FIG. 11, application of the laser to one side of the glass sheet generates a stress distribution wherein the highest compressive stresses are generated on the side of the glass sheet to which the laser was applied (indicated in FIG. 11 as “top”) as compared to the center of the sheet in the thickness direction (indicated in FIG. 11 as “center”). A peak tensile stress exists inside the sheet at the crack front which drives the crack propagation. Applicants have found that such a stress profile enables controlled, predictable, lower energy sheet separation.

It will be apparent to those skilled in the art that various modifications and variations can be made to embodiment of the present disclosure without departing from the spirit and scope of the disclosure. Thus it is intended that the present disclosure cover such modifications and variations provided they come within the scope of the appended claims and their equivalents.

What is claimed is:

1. A method for separating a glass sheet from a glass ribbon, the glass ribbon comprising a bead region, a transition region adjacent to the bead region in the widthwise direction, and a quality region adjacent to the transition region in the widthwise direction, the method comprising:
scoring a score line across a first surface of the quality region of the glass ribbon in the widthwise direction;
applying an energy source to at least one surface of the bead region next to the score line, thereby generating a thermal gradient between the at least one surface and the center of the bead region in the thickness direction, wherein the at least one surface has a temperature that is higher than the center of the bead region; and
separating the glass sheet from the glass ribbon along the score line.

2. The method according to claim 1, wherein the energy source comprises an open flame.

3. The method according claim 2, wherein the open flame is generated by hydrogen combustion.

4. The method according to claim 1, wherein the energy source comprises a laser.

5. The method according to claim 1, wherein the step of scoring a score line across the first surface of the quality region in the widthwise direction comprises applying a mechanical scoring apparatus to the first surface.

6. The method according to claim 5, wherein the mechanical scoring apparatus comprises a score wheel.

7. The method according to claim 1, wherein the step of separating the glass sheet from the glass ribbon along the score line comprises bending the glass sheet against a nosing that is applied widthwise along a second surface of the quality region opposite of the score line.

8. The method according to claim 1, wherein the step of applying an energy source to at least one surface of the bead region comprises moving the energy source along the bead region in the widthwise direction.

9. The method according to claim 1, wherein the step of applying an energy source to at least one surface of the bead region comprises moving the energy source along the bead region and the transition region in the widthwise direction.

10. The method according to claim 1, wherein score line does not extend along any portion of the bead region in the widthwise direction.

11. The method according to claim 10, wherein the energy source comprises a laser and the step of applying an energy source to the at least one surface of the bead region comprises moving the energy source in the widthwise direction such that the movement of the energy source overlaps at least a portion of the score line.

12. The method according to claim 1, wherein the step of applying an energy source to at least one surface of the bead region comprises varying the power of the energy source in the widthwise direction.

13. The method according to claim 8, wherein the step of applying an energy source to at least one surface of the bead region comprises varying the speed of movement of the energy source in the widthwise direction.

14. The method according to claim 8, wherein the step of applying an energy source to at least one surface of the bead region comprises moving the energy source along the bead region in the lengthwise direction.

15. The method according to claim 1, wherein the step of applying an energy source to at least one surface of the bead region comprises applying the energy source to the surface of the bead region that is on the same side of the glass ribbon as the score line.

16. The method according to claim 1, wherein the step of applying an energy source to at least one surface of the bead region comprises applying the energy source to the surface of the bead region that is on the opposite side of the glass ribbon as the score line.

17. The method according to claim 1, wherein the step of applying an energy source to at least one surface of the bead region comprises applying the energy source to the surfaces of the bead region that are on the same side and opposite sides of the glass ribbon as the score line.

18. The method of claim 1, wherein the step of applying an energy source to at least one surface of the bead region comprises positioning the energy source such that an angle between an incidence direction of the energy source and a plane perpendicular to the lengthwise direction ranges from 0 to 60 degrees.

19. The method of claim 2, wherein the open flame has a temperature ranging from about 1000° C. to about 3000° C. and is applied from a burner having a tip with an interior diameter ranging from about 0.01 to about 0.05 inches.

20. The method of claim 4, wherein laser applies a laser beam having a power of from about 20 watts to about 1.000 watts at scanning speeds ranging from about 1000 to about 20,000 millimeters per second.
